(19) United States
(12) Patent Application Publication
(10) Pub. No.: US 2012/0229488 A1
(43) Pub. Date: Sep. 13, 2012

(54) Method and Tool for Modifying a Procedural Map

(75) Inventor: Sebastien DEGUY, Clermont-Ferrand (FR)

(73) Assignee: ALLEGORITHMIC, Aubiere (FR)

(21) Appl. No.: 13/267,364

(22) Filed: Oct. 6, 2011

Related U.S. Application Data
(63) Continuation of application No. 13/032,363, filed on Feb. 22, 2011, now abandoned.
Application No. 13/032,363 is a continuation of application No. 12/398,883, filed on Mar. 5, 2009, now abandoned.
Application No. 12/398,883 is a continuation of application No. 10/597,087, filed on Jul. 11, 2006, now abandoned.

(51) Int. Cl. G09G 5/00

(52) U.S. Cl. 345/582

(57) ABSTRACT

Method for modifying a procedural map for use with a tree driven procedural map comprising a plurality of levels (at least two levels) each having at least one node associated to at least one parameter, comprising the steps of: providing a node selection tool allowing the selection of at least one node of one level among the plurality of nodes of a map to be modified; select a given node according to a given input; provide a parameter modification tool allowing the modification of at least one parameter of the selected node; modify said parameter of said node based on a given input; calculate a modified map based on the modified parameters. The invention also provides the map generation and modification tools for the implementation of this method.

### CROSS-REFERENCE

This application is a continuation of U.S. patent application Ser. No. 13/032,363, filed Feb. 22, 2011, now abandoned. The '363 application is a continuation of U.S. patent application Ser. No. 12/398,883, filed Mar. 5, 2009, now abandoned. The '833 application is a continuation of U.S. patent application Ser. No. 10/597,087, filed Jul. 11, 2006. The ’087 application is the United States National Stage of International Application Number PCT/EP2004/000661, filed Jan. 12, 2004. Each of the foregoing applications are incorporated by reference herein in their entirety.

### FIELD OF THE INVENTION

The present invention relates to computer graphics, and in particular to procedural maps, applied in various environments such as shader. Shader relates to the surface properties of a given simulated material. It may for instance define the type of reaction of a surface to its surrounding environment, and in particular to lighting. This reaction may follow a given lighting model such as one of the following: Phong, Gouraud, Blinn, etc. All these properties could be defined using constant values. However, maps allow to define more complex environments such as 2D or 3D environments, or time dependant parameters. Shaders may be used or applied either in 2D (surface) or 3D (volume) applications. They involve for instance, texture, displacement, bump, reflectivity, specularity, transparency, color, etc.

### BACKGROUND OF THE INVENTION

Procedural maps are well known in computer science, in particular in computered design, imaging or drawing. Three main techniques are currently used in the industry in order to produce maps. These techniques are now exemplified in the field of textures. However, similar comparisons are possible in other fields of shader.

First, the use of libraries. Depending on the type of design to prepare, specialized libraries are available to provide a wide selection of existing textures, in various fields, such as wood, stone, clouds, terrain, etc. These “of the shelf textures are easy to use, and easy to install in a wide variety of different applications. However, they are of a given (finite) dimension. If the application relates to the use of a large size texture, in particular larger than the current size of the standard existing texture of the library, the user has to duplicate the texture a certain number of times, depending on the size of its application. If many duplications are necessary, the resulting “enlarged” texture could look like a kind of puzzle or “patchwork”, using a unique tile or path many times. The resulting effect may be far away from the original intention to provide a uniform and homogeneous wide size texture. In addition to this, the possibilities to modify the resulting large size texture are very limited and necessitate an important amount of work.

The second technique relates to the uses of photographs of original textures. This technique has the same drawbacks as the first one, that is to say the given (limited) size of the image, and the difficulties to modify a texture. For instance, if an original texture is photographed with a given type of light with a certain angle, this may not be appropriate for the particular further use of the picture. Modifications and corrections may only be made using known type image processing tools and software. However, these tools are rather time consuming. Moreover, the formats used to save the related images require important memory space.

The third type of technique relates to the use of known drafting tools such as Adobe Photoshop™, allowing to construct a texture. The preceding drawbacks (except the required memory space) do not, in theory, apply to this technique. However, the time required to produce textures is very important. “Hand-made” textures are thus very expensive to produce because the process is time and resource consuming, and cannot be used at large scale at a reasonable cost.

Shaders and textures using procedural maps have been developed in recent years to try to avoid these various drawbacks. However, with current methods, it is not possible to modify the resulting maps, shaders or textures.

### SUMMARY OF THE INVENTION

To avoid these (and further) drawbacks, the invention provides a method for modifying a procedural map for use with a tree driven procedural map comprising a plurality of levels (at least two levels) each having at least one node associated to at least one parameter, comprising the steps of:
providing a node selection tool allowing the selection of at least one node of one level among the plurality of nodes of a map to be modified;
select a given node according to a given input; (the given input may be provided by a user, by a machine or by a computer program working in cooperation with the node selection tool);
provide a parameter modification tool allowing the modification of at least one parameter of the selected node;
modify said parameter of said node based on a given input; (the given input may be provided by a user, by a machine or by a computer program working in cooperation with the node selection tool);
calculate a modified map based on the modified parameters.

In a variant, the modified parameters are recursively affected to the children nodes of said selected node.

According to an example of the invention, the tree driven procedural map is represented by the following equation:

$${\sum }_{( j , k ) ∈ T} F ( {2}^{j} x - k )$$

wherein:
F is a function Rⁿ→R
x is a vector of the type (x₁, x₂, . . . , xₙ);
T is a tree comprising nodes (j, k) and wherein
   j indicates the current level, among a total potential number of levels jmax (j ε(0, 1, 2, . . . , jmax)
   k is a displacement vector for each node N and of the type (x₁, x₂, . . . , xₙ).

The possibility to modify a map on a local basis or scale, is possible due to the tree arrangement of the map. Such a structure allows to act locally, for instance on a node or a branch, without affecting the remaining nodes or branches. Moreover, the tree arrangement allows to provide recursive or non-recursive modifications. The method and tools of the invention allow to operate either on a local (node) or global (entire map) basis or scale.

The modifiable parameters are advantageously selected in the list comprising: the morphlet F, the maximum number of levels (jmax).

In a variant, the tree may comprise an intermittency parameter (p). In a further variants, the tree may also comprise a displacement parameter (D), a Hurst parameter (H) (for instance a roughness value), a random value (ξ).

In another example, the tree driven procedural map is represented by the following equation:

$${\sum }_{( j , k ) ∈ {T}_{D , p}} {2}^{- j H} F ( {2}^{j} x - k ) {ξ}_{( j , k )}$$

wherein:
F is a function Rⁿ→R
x is a vector of the type (x₁, x₂, . . . , xₙ);
T_{D,p} represents a tree provided with an intermittency parameter (p), and comprising nodes (j, k) and a displacement value (D), wherein
   j indicates the current level, among a total potential number of level jmax (j ε(0, 1, 2, . . . , jmax)
   k is a displacement vector for each node N and of the type (x₁, x₂, . . . , xₙ)
H represents a Hurst parameter, for instance a roughness value;
ξ represents a random number.

According to this equation, the modifiable parameters are advantageously selected in the list comprising: the morphlet F, the maximum number of levels (jmax), a Hurst parameter (roughness value) (H), a random number (ξ), an intermittency parameter (p), a displacement value (D).

The procedural map may be a texture map, or the procedural map type may be selected from the list comprising: displacement, bump, reflectivity, specularity, ambient color, diffuse color, specular color, transparency, color, shininess, self-emission, anisotropy, refractive index.

The sum (of the above equations) is advantageously a generalised sum. Thus, any type of operation or function may be provided, such as substraction, maximum, multiplication, etc.

In another variant, the map is time dependant: any, or all parameter may be time dependant. This type of map is very important for many types of applications related to animation, video, etc. The present method and tools also apply to these maps.

The invention also provides a software product, or computer program product readable by a computer and encoding instructions for executing the above mentioned computer process.

The invention also provides a procedural map modification tool for use with a tree driven procedural map comprising a plurality of levels (at least two levels) each having at least one node associated to at least one parameter, comprising:
a node selection tool allowing the selection of at least one node of one level among the plurality of nodes of a map to be modified;
a parameter setting tool allowing the modification of at least one parameter of the selected node;
a processing unit, for the processing of said parameters to generate a map;
operating instructions, for the operation of said tool and namely of the processing unit.

In a variant, the tool is advantageously adapted for the modification of a tree driven procedural map represented by the following equation:

$${\sum }_{( j , k ) ∈ T} F ( {2}^{j} x - k )$$

wherein:
F is a function Rⁿ→R
x is a vector of the type (x₁, x₂, . . . , xₙ);
T is a tree comprising nodes (j, k) and wherein
   j indicates the current level, among a total potential number of levels jmax (j ε(0, 1, 2, jmax)
   k is a displacement vector for each node N and of the type (x₁, x₂, . . . , xₙ).

The tool is advantageously adapted for the modification of at least one parameter selected in the list comprising: the morphlet F, the maximum number of levels (jmax).

In another variant, the tool is advantageously adapted for the modification of a tree driven procedural map represented by the following equation:

$${\sum }_{( j , k ) ∈ {T}_{D , p}} {2}^{- j H} F ( {2}^{j} x - k ) {ξ}_{( j , k )}$$

wherein:
F is a function Rⁿ→R
x is a vector of the type (x₁, x₂, . . . , xₙ);
T_{D,p} represents a tree provided with an intermittency parameter (p), and comprising nodes (j, k) and a displacement value (D), wherein
   j indicates the current level, among a total potential number of level jmax (j ε(0, 1, 2, . . . jmax);
   k is a displacement vector for each node N and of the type (x₁, x₂, . . . , xₙ)
H represents a Hurst parameter (for instance a roughness value);
ξ represents a random number.

In a variant, the tool is advantageously adapted for the modification of at least one parameter selected in the list comprising: the function F, the current level (j), the maximum number of levels (jmax), a Hurst parameter (H) (roughness value), a random value (ξ), an intermittency parameter (p), a displacement value (D).

The node selection tool is advantageously provided with a “deepness” selection unit allowing the selection of a given level (j) of said tree.

The node selection tool advantageously comprises a movable screen target, for the localisation and/or selection of a node-object. The movable screen target may be operable with a computer cursor displacement device.

The map modification tool is advantageously comprised in a tree driven procedural map generation tool.

The invention also provides a procedural map generation tool, for the generation of tree driven procedural maps comprising a plurality of levels (at least two levels) each having at least one node associated to at least one parameter, comprising:
a map parameter input unit, for the input of the procedural map parameters;
a map processing unit, for the processing of the parameters, (to obtain a map);
operating instructions, for the operation of said tool and namely of the processing unit;
a map modification tool, comprising:
   a node selection tool allowing the selection of at least one node of one level among the plurality of nodes of a map to be modified;
   a parameter modification tool allowing the modification of at least one parameter of the selected node.

The procedural map generation tool advantageously comprises an output for a map display unit, allowing the presentation of said map on a display.

### BRIEF DESCRIPTION OF THE DRAWINGS

Objects, features, advantages and alternative aspects of the invention will become apparent to those skilled in the art from a consideration of the following detailed description taken in combination with the accompanying drawings, which illustrate:

FIGS. 1 to 20 illustrate different examples of layers and maps;

FIGS. 21 to 25 illustrate examples of local modifications on maps;

FIGS. 26 to 30 show examples of different trees: FIG. 26 shows a basic tree and the other figures show how a tree may be modified with the modification of at least one of its parameters;

FIG. 31 show the two main types of parameters;

FIGS. 32 to 37 illustrates examples of interfaces of the tool of the invention.

### DETAILED DESCRIPTION

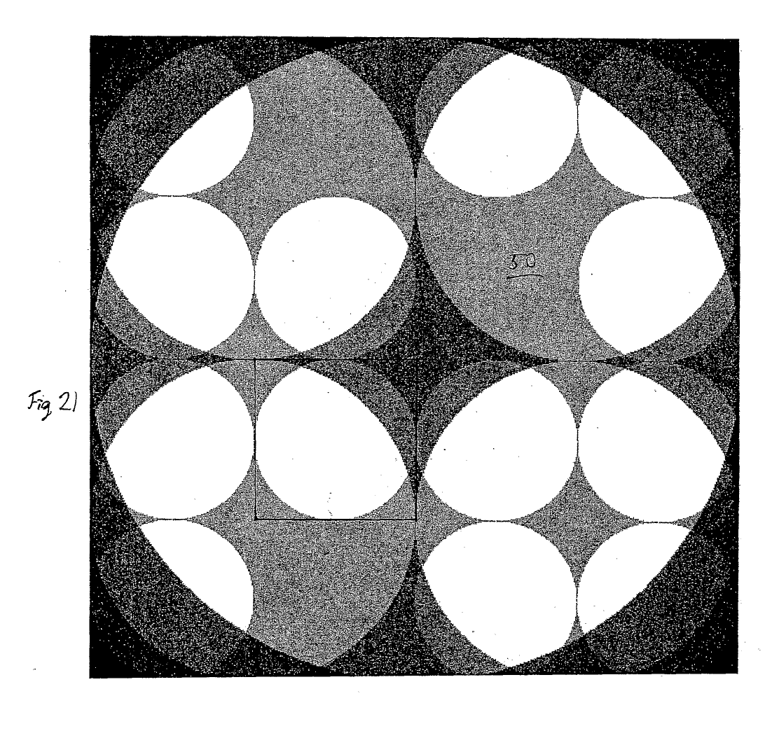

The present invention is based on the use of tree driven procedural maps. FIGS. 21 to 25 illustrate examples of structures of such a tree (in the specific case for which n=1, wherein n is the dimension of the support. For instance, n=2 for an image, n=1 for a curve, n=3 for a volume). In the example of FIG. 21, at j=0, a single node is provided. Two children nodes are provided at level j=1, and four at level j=2. All nodes are similar. The function F, providing a major contribution to define the basic shape of the node-object, is also called in this document a “morphlet”. This word takes its origin from the Greek prefix “morph” and the word “wavelet”. A morphlet can be of almost any type of shape. Such a tree driven map may be represented by the following equation:

$${\sum }_{j} {\sum }_{k} F ( {2}^{j} x - k ) , ( j , k )$$

forming a tree T, and also represented in this document by:

$${\sum }_{( j , k ) ∈ T} F ( {2}^{j} x - k )$$

wherein:
F is a function or morphlet Rⁿ→R
x is a vector of the type (x₁, x₂, . . . , xₙ);
T is a tree comprising nodes (j, k) and wherein
   j indicates the current level, among a total potential number of levels jmax (j ε(0, 1, 2, . . . jmax);
   k is a displacement vector for each node N and of the type (x₁, x₂, . . . , xₙ).

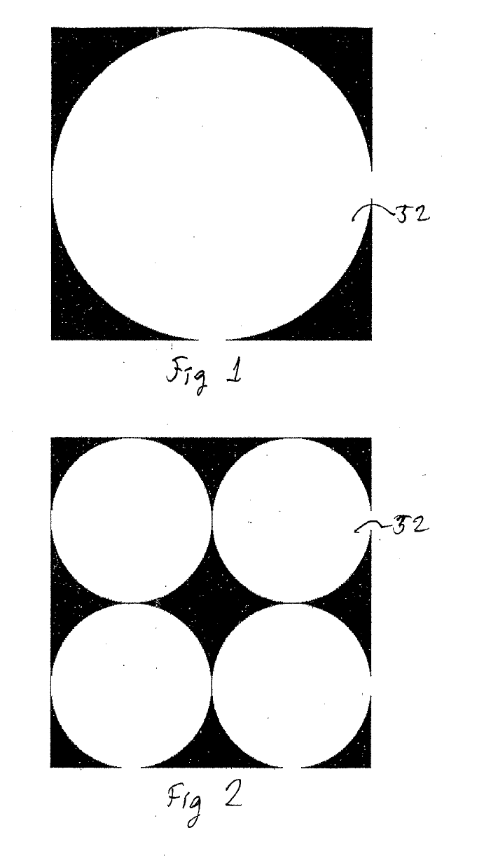

FIGS. 1, 2 et 3 illustrate different steps for the generation of a tree driven procedural map according to the basic, or simplified, mathematical equation, as previously described. FIG. 1 illustrates the layer formed at the first level (j=0), with the following morphlet F=1 if x²+y²<1, otherwise F=0. At j=0, with a single node, a single node-object (NO) is provided, in the form of a uniform and centered disk.

FIG. 2 illustrates the second layer, formed at the second level (j=1) for the same morphlet F. The layer is provided with four node-objects, in this example, four disks of smaller size, each one being of uniform size and shape. The layer is divided in four sections, each forming a node-object. Each section fills one quarter of the initial map size, according to a uniform and symmetrical quadratic arrangement. In each node-object, a disk, similar to the disk of the previous level (j=0) in FIG. 1 , but four times smaller, is provided.

The effect of each parameter, from one level to another one, is thus clearly visible. The parameter j indicates the current level, the parameter k allows the displacement of a node-object, in this example from the center of the map to the center of a quarter. The morphlet F remains unchanged from one level to the other.

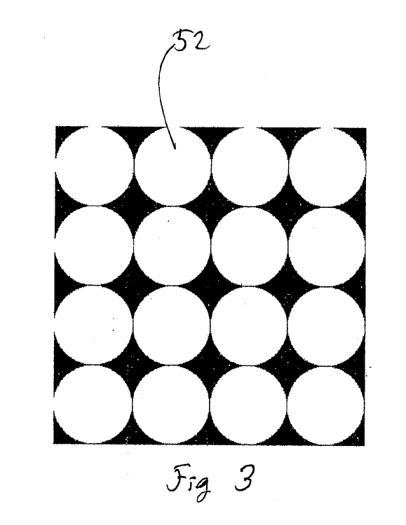

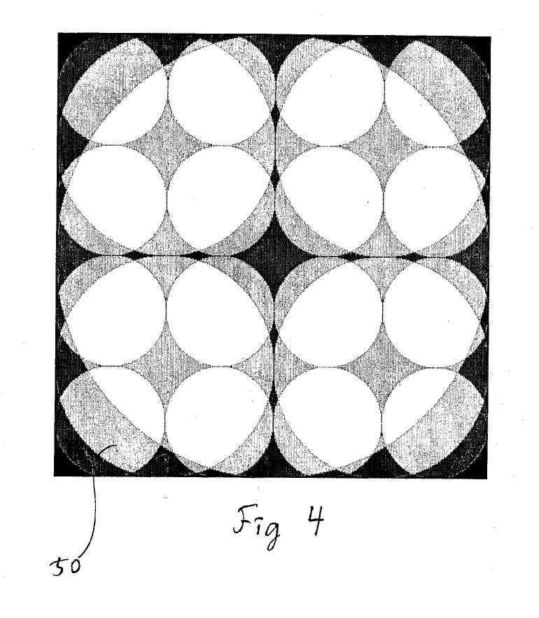

FIG. 3 illustrates the third layer (j=2) also for the same morphlet F. Once again, each node-object of the previous level is divided into 4 sections. Each quarter is provided with a node-object, in this example similar to the disks of the previous level, but four times smaller.

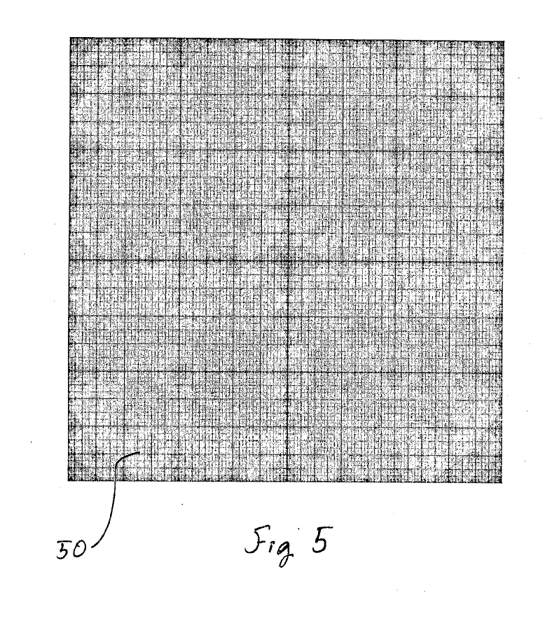

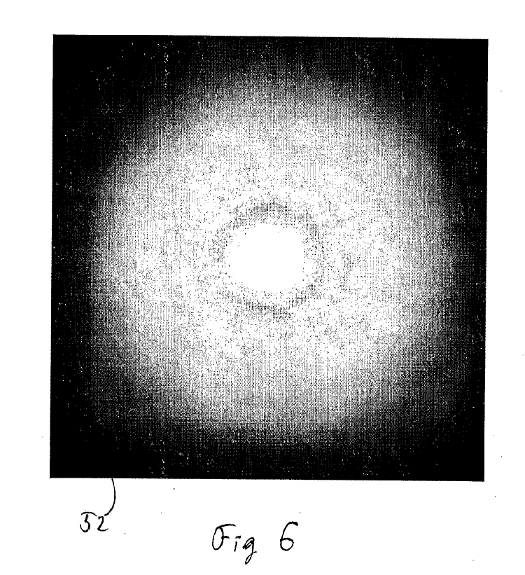

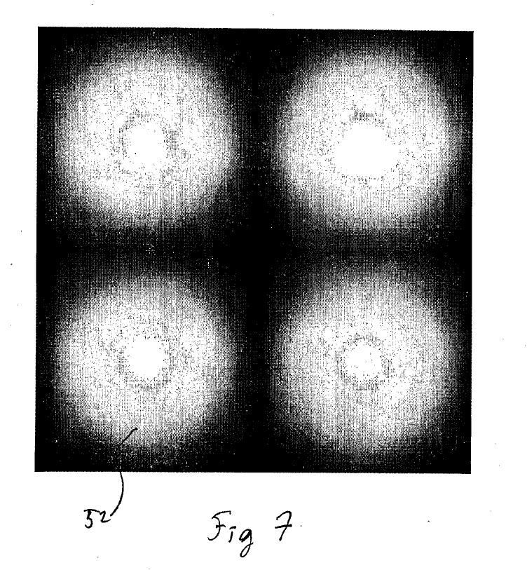

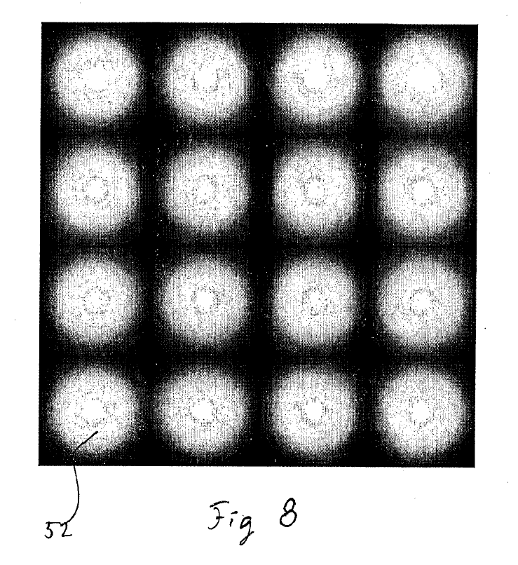

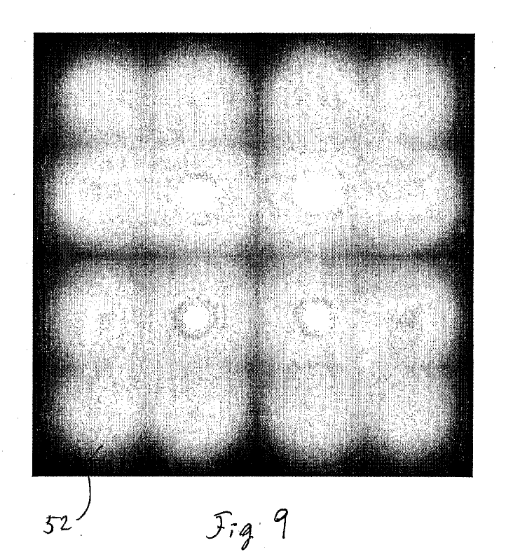

FIG. 4 illustrates the sum of these three layers. Due to the very simple shape of each node-object of each layer, provided by this exemplified morphlet, it is possible to see in FIG. 4 the various disks of various sizes corresponding to the different levels from j=0 to j=2. Of course, if a complex function is used, or if more levels are considered, the probability to be able to distinguish each node-object of each level is then reduced.

FIG. 5 illustrates a similar sum of multiples sub-maps, using the same morphlet as FIGS. 1 to 4, but with a larger number of levels, thus involving a higher number of node-objects. In fact, in this example, jmax=log₂ (display resolution), which means that the number of levels (jmax) is a function of the display resolution. The size of a node-object is limited to the size of a pixel. Though the sum could be provided for a larger number of levels, the result could not be visible on the display. In this case, such a “deeper” map is thus in practice of theoretical interest.

FIGS. 6 to 10 are comparable to FIGS. 1 to 4, but with a different morphlet: F(x,y)=exp(−x²−y²). The resulting node-object is then a two dimensional Gauss type function, instead of a disk. The comparison of the figures of similar layers, for instance FIGS. 1 and 6 for j=0, FIGS. 2 and 7, for j=1, FIGS. 3 and 8 for j=2, allows to observe the effect of the morphlet modification. Similar structures are provided, with node-objects having a different look or aspect.

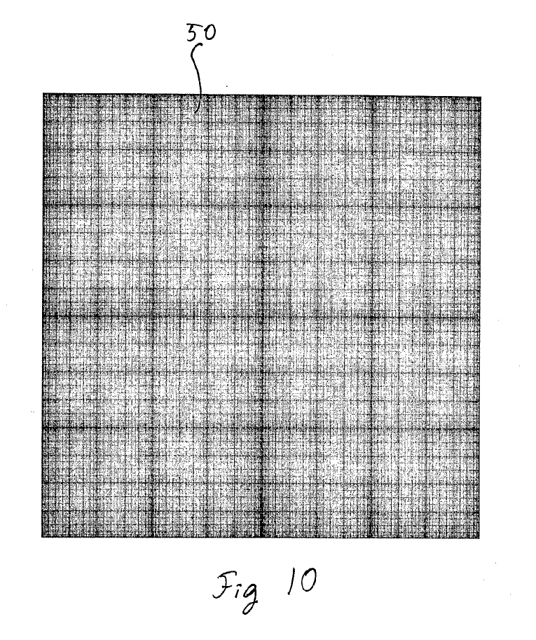

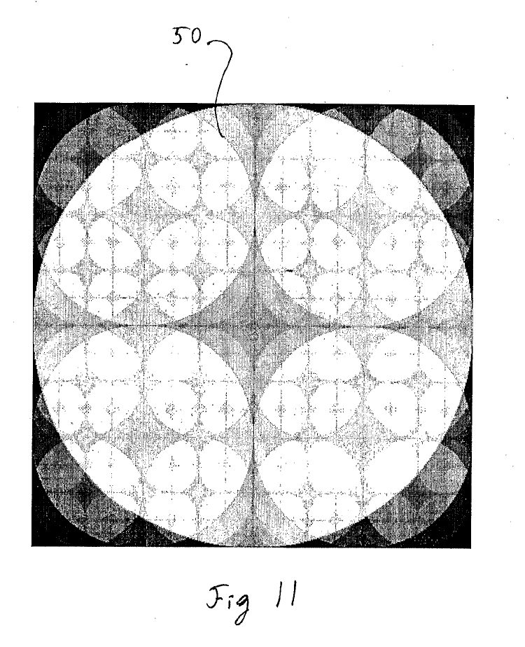

The comparison of FIGS. 4 and 5 respectively with FIGS. 9 and 10 reveals similar effects, first with a low number of levels (jmax=2) in FIGS. 4 and 9, and then, in FIGS. 5 and 10, with a number of levels adjusted to correspond to the size of a pixel.

In the previous examples, from level j to level j+1, the support size is divided by two. If the amplitude of the function or morphlet to sum is kept unchanged, the energy level in the node-object is doubled. To avoid this situation, and to control the energy level from one level to the other, the equation may be adapted (adding 2^{-j} to the equation), with the following result:

$${\sum }_{( j , k ) ∈ T} {2}^{- j} F ( {2}^{j} x - k )$$

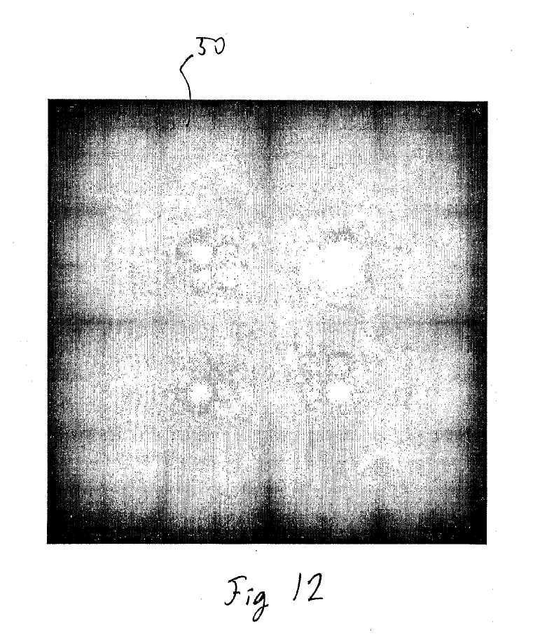

FIG. 11 illustrates a disk shaped morphlet, with j=jmax, with the modified equation to consider the energy levels. The resulting map is clearer as compared with FIG. 5. FIG. 12 is similar to FIG. 5, but based on a Gauss type morphlet.

In the previous examples, the maps are always configurated with a uniform structure, systematically repeated at each level or layer. The resulting maps, in particular when used to define procedural textures, may sometimes have a tendency to look rather <<artificial>>. This is mainly due to the fact that natural objects are in general not based on such uniform, and rigorously repetitive structures. Thus, in order to better simulate natural objects, the mathematical equation, in a further variant, may be completed with a random number ξ_{(j, k)}.

The resulting mathematical equation is thus:

$${\sum }_{( j , k ) ∈ T} {2}^{- j} F ( {2}^{j} x - k ) {ξ}_{( j , k )}$$

where ξ is a random number.

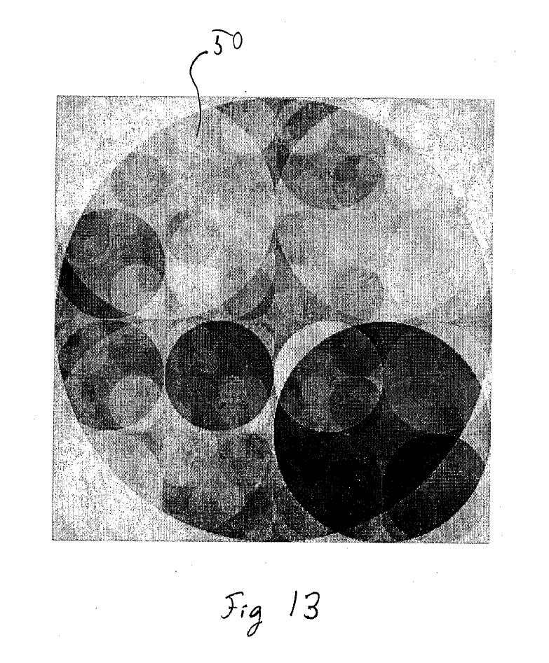

In the case of a map having of a tree structure including a random number, the tree is no longer homogeneous and the distribution of the different node-objects is based on a given random law for ξ_{(j, k)}. FIG. 13 illustrates a procedural map obtained with such an equation, provided with a random number. It can clearly be observed that the typical quadratic regular structure of the preceding examples is no longer reproduced in this example. The orientation and structure of the map is partly influenced by a random number. The importance of this influence may be adjusted by the selection of a higher or lower value of the parameter. For instance, the example of FIG. 13 corresponds to the example of FIG. 11, with ξ_{(j, k)} being a random variable of uniform law comprised between −1 and +1.

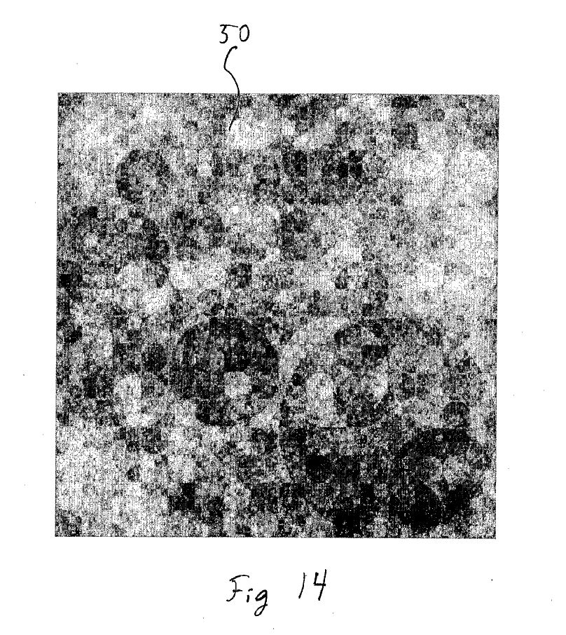

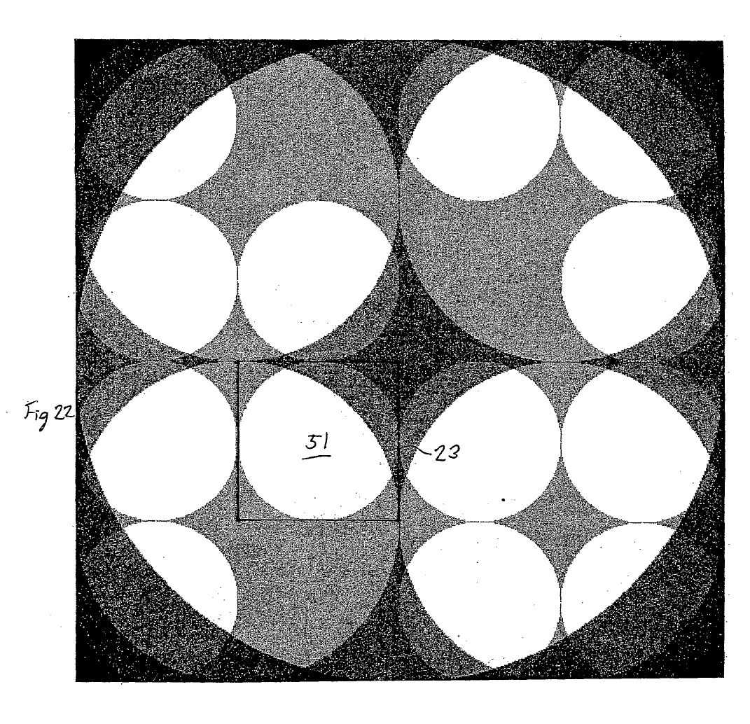

In a further variant, the mathematical equation may still be optimised with the use of a HURST parameter, designated H. For a given map, H is advantageously a constant. For example, H ε[0, 1]. This parameter contributes to the management of scale laws in self-similar processes. With the use of this parameter, the tree driven sum process is then self-similar by itself. Following such a law, even after a change of scale, a similar object is observable as before the scale modification. For instance, a cloud fragment looks like a complete cloud. H is also linearly linked to the fractal dimension. For a low value of H, the signal is irregular, and the fractal dimension is high. In texture maps, the Hurst parameter corresponds in practice to a roughness parameter. With H→1, the surface is smoother; with H→O, the surface becomes rougher, as illustrated in FIGS. 14 to 16. FIG. 22 illustrates an example of a tree comprising nodes having different H values.

In FIG. 14, the example of FIG. 13 is used, with H=0.2.

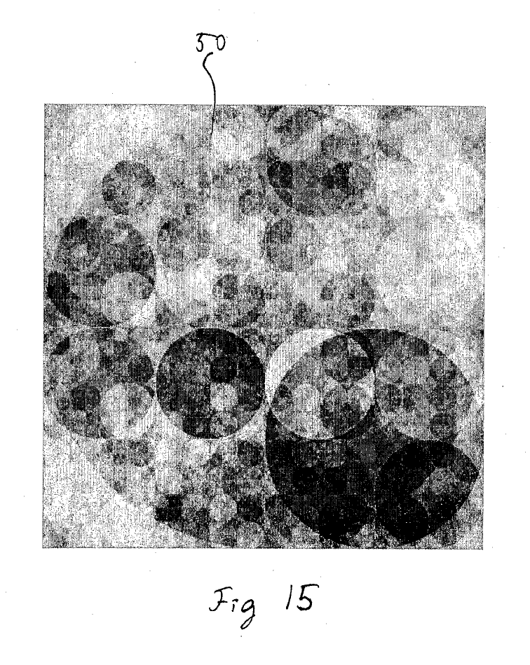

In FIG. 15, the example of FIG. 13 is used, with H=0.5.

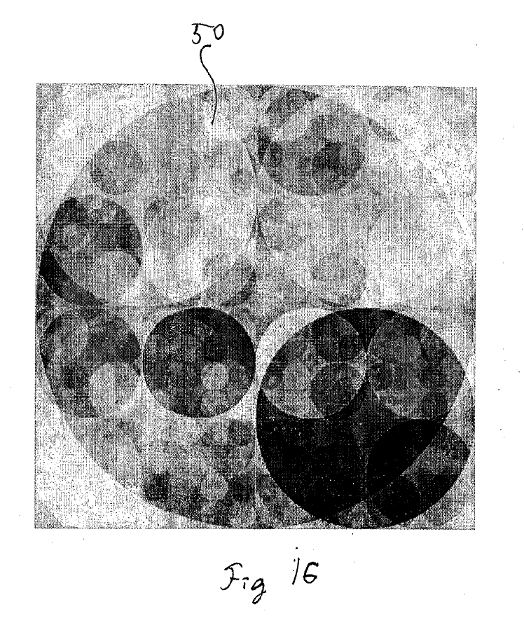

In FIG. 16, the example of FIG. 13 is used, with H=0.8.

The resulting mathematical equation is then:

$${\sum }_{( j , k ) ∈ T} {2}^{- jH} F ( {2}^{j} x - k ) {ξ}_{( j , k )}$$

wherein:
F is a function Rⁿ→R
x is a vector of the type (x₁, x₂, . . . , xₙ);
T represents a tree comprising nodes (j, k), wherein
   j indicates the current level, among a total potential number of levels jmax (j ε(0, 1, 2, . . . , jmax);
   k is a displacement vector for each node N and of the type (x₁, x₂, . . . , xₙ).
H represents the Hurst parameter;
ξ represents a random number;

In another variant, the mathematical equation may be further improved with the addition of Tₚ representing a tree provided with an intermittency parameter (p), and comprising nodes (j, k), with the resulting equation:

$${\sum }_{( j , k ) ∈ {T}_{p}} {2}^{- jH} F ( {2}^{j} x - k ) {ξ}_{( j , k )}$$

wherein:
F is a function Rⁿ→R
x is a vector of the type (x₁, x₂, . . . , xₙ);
Tₚ represents a tree provided with an intermittency parameter (p), and comprising nodes (j, k), wherein
   j indicates the current level, among a total potential number of levels jmax (j ε(0, 1, 2, . . . , jmax);
   k is a displacement vector for each node N and of the type (x₁, x₂, . . . , xₙ).
H represents a roughness parameter;
ξ represents a random parameter.

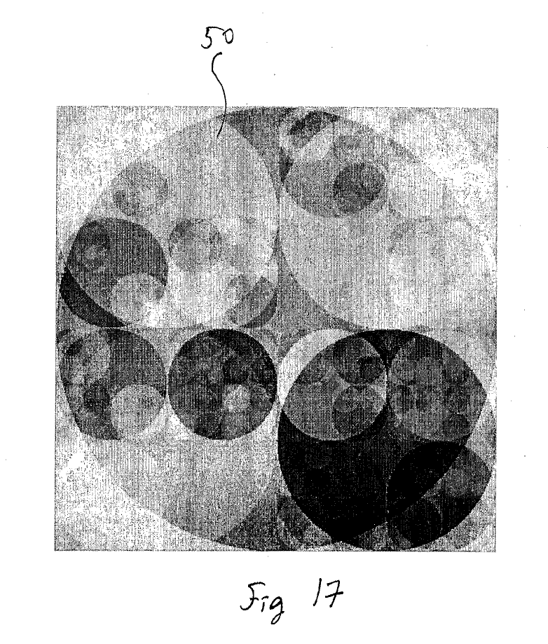

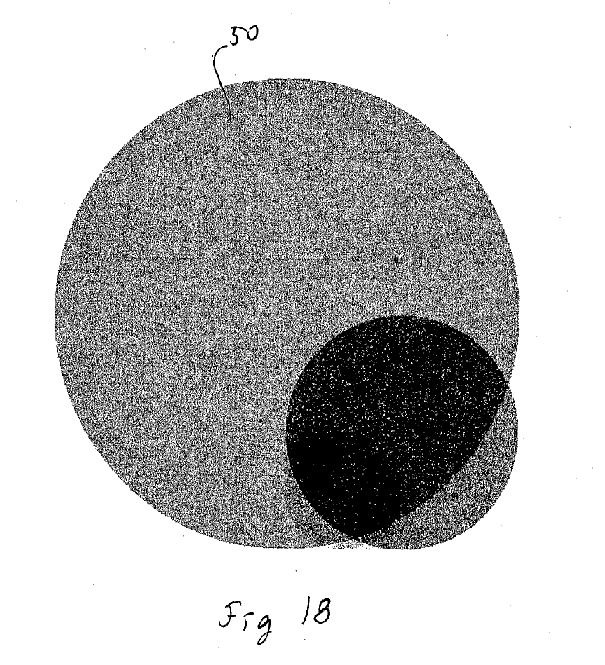

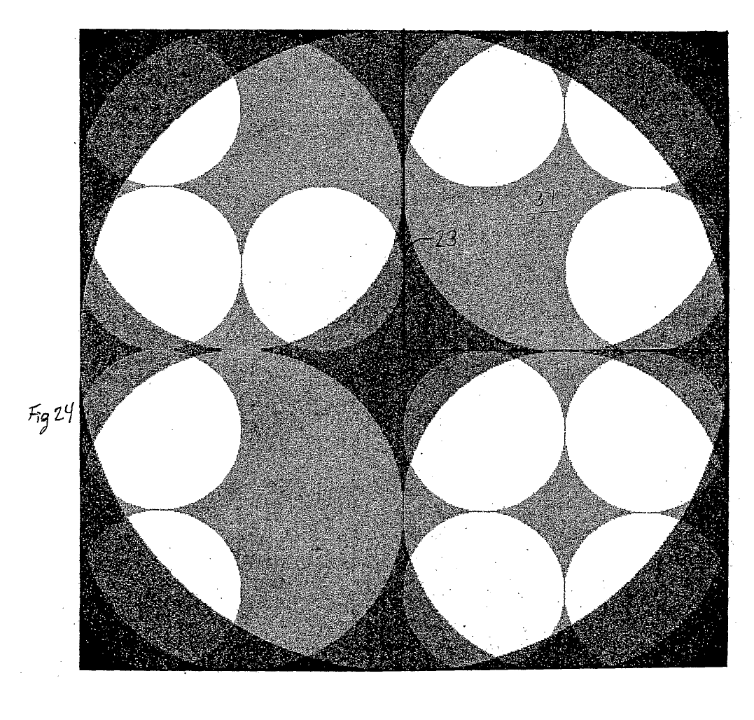

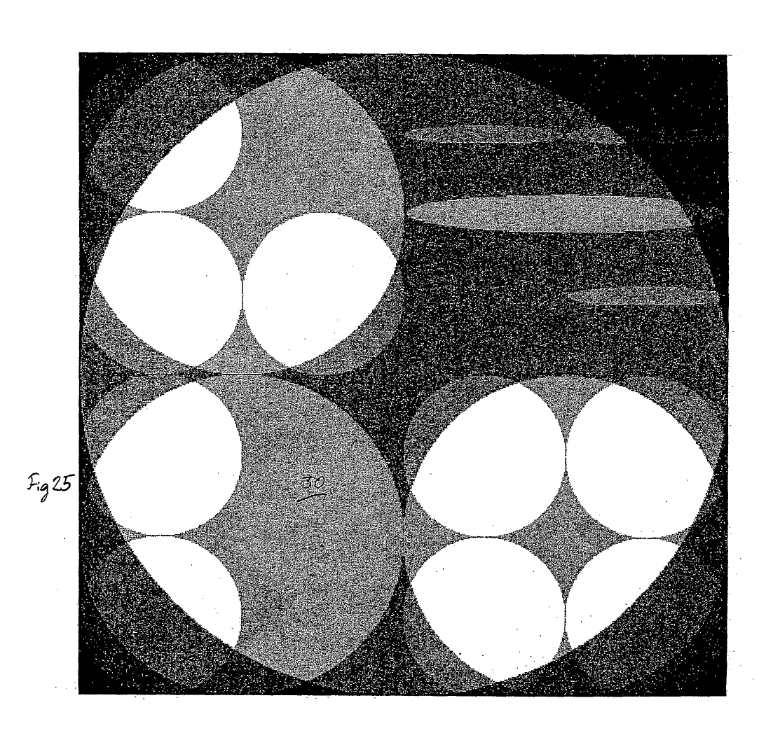

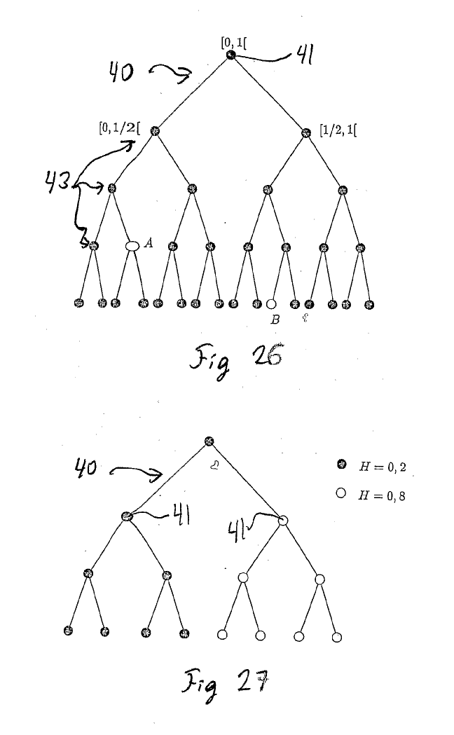

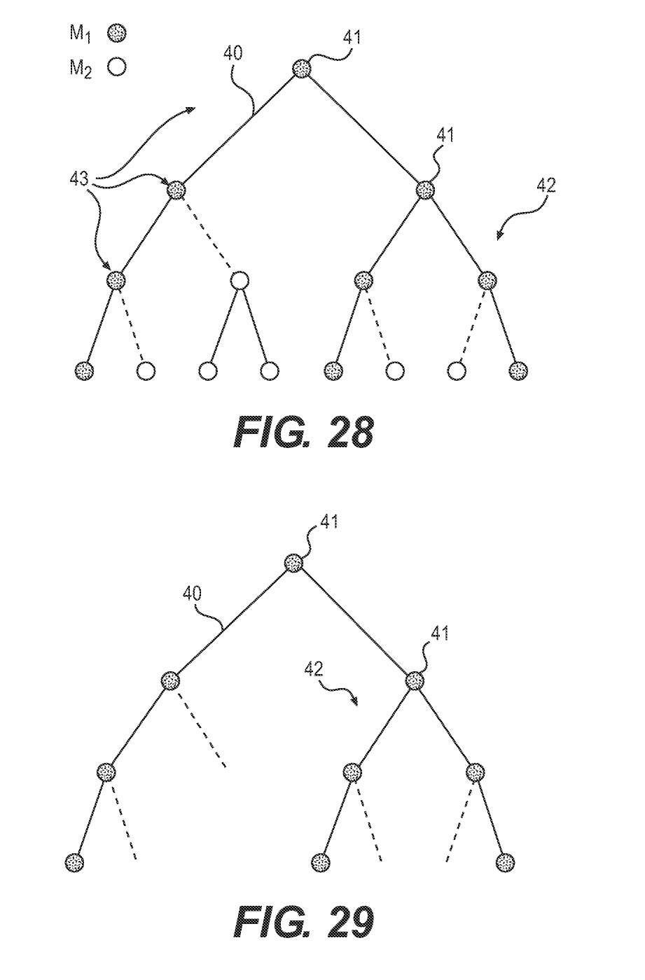

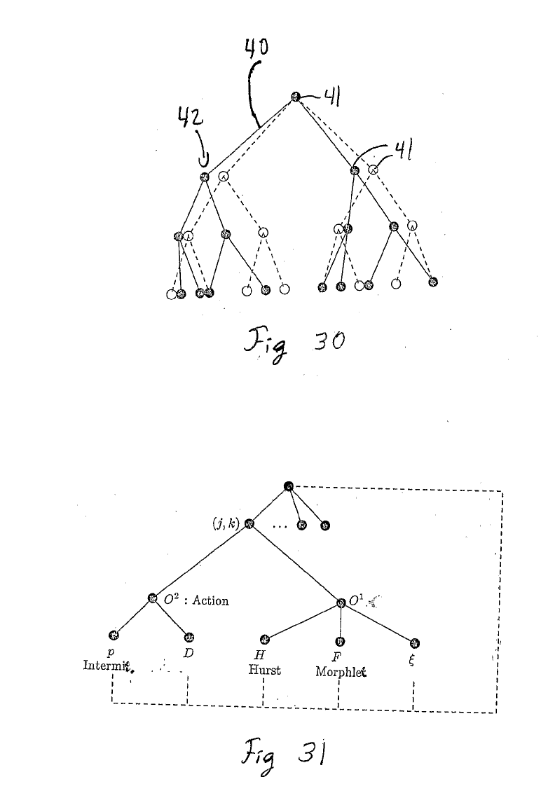

p represents a probability to suppress branches of the tree T. For instance, in FIG. 17, p=0.2, meaning a probability of 0.2 to suppress branches (or sub-trees) of the tree T. In FIG. 18, p=0.8, meaning a probability of 0.8 to suppress branches (or sub-trees) of the tree T. FIG. 24 illustrates an example of a tree influenced with a given value of a parameter p. The example shows that some nodes have been suppressed, or are not existing.

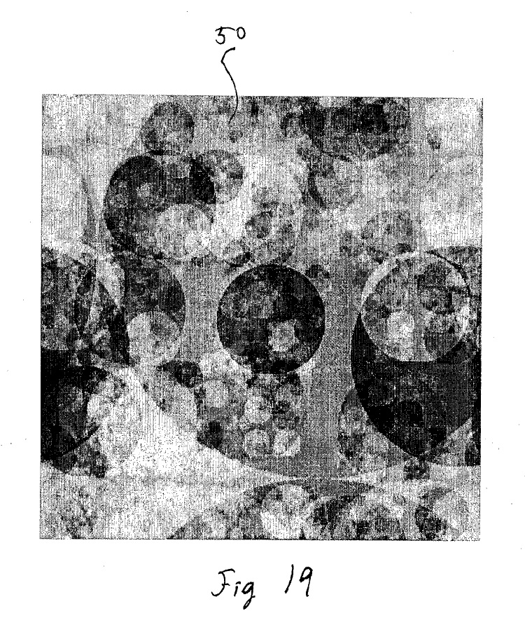

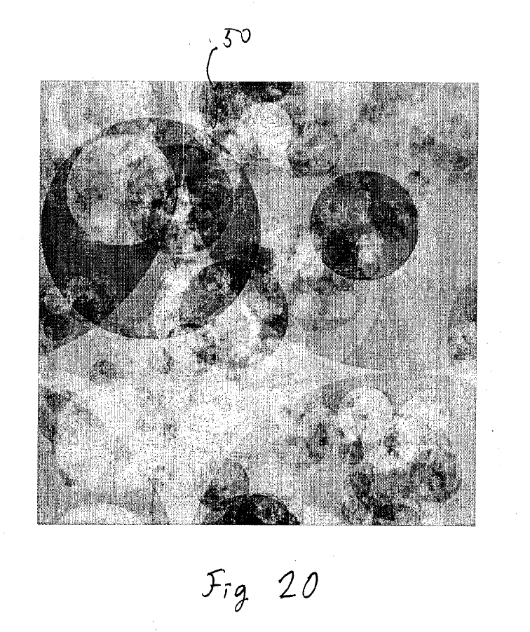

The tree structure or configuration also allows to provide a further specific effect or map modification, with a further parameter, D, corresponding to a displacement of one of more nodes from their original positions. FIGS. 19 and 20 illustrate this possibility. In these figures, using a similar example as FIG. 15, p=0 and D=0.2. That is to say, the probability to displace a node-object is between 0 and 20%. In FIG. 20, D=0.5. The comparison between the two figures clearly shows the stronger displacement of some of the node-objects, based on a random law. FIG. 25 illustrate an example of a tree influenced with the use of a displacement D.

The corresponding equation is then :

$${\sum }_{( j , k ) ∈ {T}_{D , p}} {2}^{- jH} F ( {2}^{j} x - k ) {ξ}_{( j , k )}$$

wherein:
F is a function Rⁿ→R
x is a vector of the type (x₁, x₂, . . . , xₙ);
T_{D,p} represents a tree provided with an intermittency parameter (p), and comprising nodes (j, k), and a displacement D, wherein
   j indicates the current level, among a total potential number of levels jmax (j ε(0, 1, 2, . . . , jmax);
   k is a displacement vector for each node N and of the type (x₁, x₂, . . . , xₙ).
H represents a roughness value;
ξ represents a random number.

Of course, different equations are also possible, by the suppression or addition of one or more parameters, for instance in the different sequence than the one presented in the previous examples. Any other equation using a different combination of these parameters is also considered within the scope of the present invention.

FIG. 31 illustrates a different definition of the nodes of a tree based on the type of effect of each parameter. Two families or categories of parameters are illustrated: “action” parameters, such as intermittency p and displacement D, and “structural” parameters, such as the Hurst parameter H, the morphlet F and the random parameter ξ.

### Modifications of an Existing Map

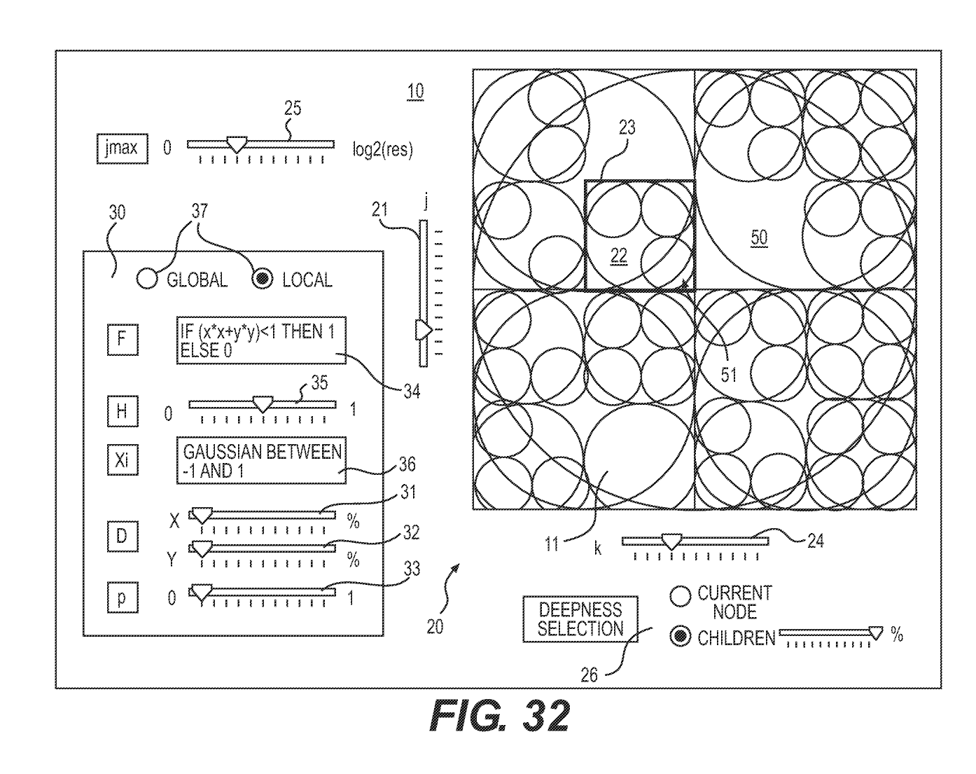

FIG. 32 illustrates an example of a working interface provided by a map generation/modification tool 10 according to the invention. According to different variants of the invention, such a tool may be provided either for the modification of maps, or for the generation and modifications of maps.

According to the invention, the map generation/modification tool 10 comprises a node selection tool 20, having a level (J) selection unit 21 and a node selection unit 22, which allows the selection of a node in the selected level. In practice, as described herebelow, the user will select a layer (corresponding to a given level (j)) and a node-object (corresponding to a node (k)).

The map generation/modification tool 10 also comprises a parameter setting tool 30 allowing to select a parameter to modify and set its value (either new or modified). To perform a modification of a given map 50, a node 41 or a plurality of nodes shall first be selected. The node selection tool 20 provides this possibility. Such a tool is advantageously provided with at least two features or functions: a level selection unit 21, such as a cursor, as in FIG. 27, and a node selection unit 22.

The node selection unit is provided with a mobile screen target 23. The movable screen target 23 is advantageously shaped in order to delimit at least one node-object 51 in a given layer. In the various examples, the display 23 is of a substantially square shape. To make easier the selection of nodes, the tool is advantageously provided with a displacement mode such as to allow the automatic positioning of the display on a node-object or a set of nodes, for instance the nearest ones, when the movable screen target is not properly positioned on a given node-object. The movable screen target may be controlled with any known computer command such as a mouse, a pointer, keyboard keys such as for instance the arrows, or a remote control unit such as a command software, circuit or machine. It may also be controlled directly from the interface of the node selection tool 20, for instance with a cursor 24 controlling the positioning of the movable screen target 23 in the map.

In addition to FIGS. 32, 33 and 34, the example of FIG. 22 illustrates the node selection unit 22 provided with a movable screen target 23. Once a level is selected, the size and shape of the movable screen target 23 is adapted to the size and shape of the node-object 51 of the selected level. The movable screen target allows to select any node of the selected level.

The node selection tool 20 is advantageously provided with a node enhancement feature, allowing to indicate to the user which nodes are selected. Such an indication may be provided either with a change of color or brightness or with a flashing mode, or any other visual indication.

The map modification tool 10 is also preferably provided with a deepness selection unit 26, allowing to user to indicate if the modifications relate only to the nodes of the given level, or if the sub-trees shall also be modified accordingly. In such a case, all dependent nodes, or a certain proportion or percentage of them are modified with the selected nodes with the same modifications.

The parameter setting tool 30 allows first to select which parameter shall be modified, and the new value of this parameter. The parameter setting tool 30 allows the selection and modification of at least one parameter, and preferably of many parameters, such as, for instance the parameters previously described in this document: F: 34, H: 35, ξ: 36, p: 33, D(x): 31 , D(y): 32.

The map modification tool 10 preferably comprises two modes: Global (G)/Local (L). The global mode is selected with selector 37 to modify an entire map. The level and node selection units are then either not used or desactiviated. The modification of one or more parameters is performed as described earlier, but, according to this mode, it applies to the complete map, and the step relating to the selection of a level and a node-object are not required. If the local mode is selected, local modifications are possible. Local modifications means modification performed at the scale of the node-objects, for at least one node-object.

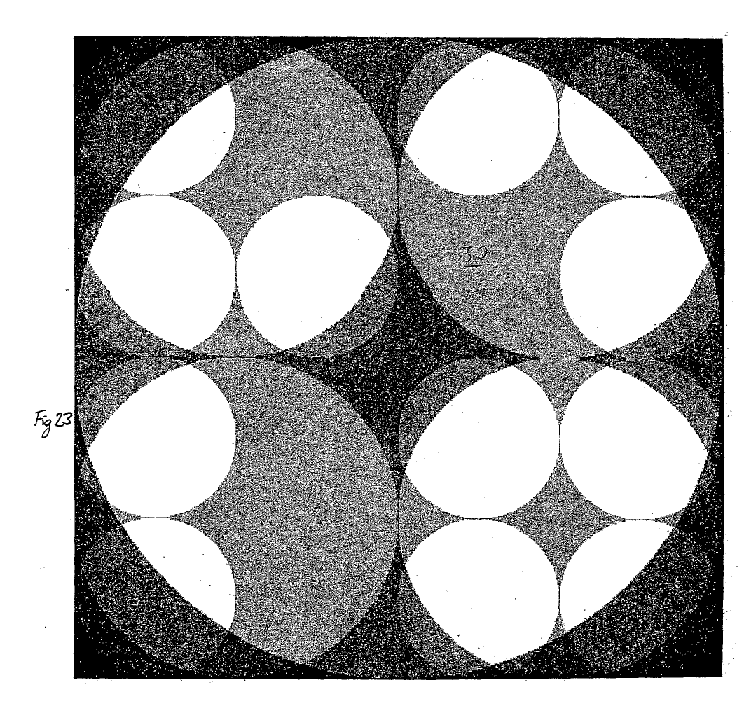

As a variant, the modification tool 10 may provide the possibility to delete or suppress a node or a set of nodes. FIGS. 22 and 23 illustrate an example of such a nodes suppression: in FIG. 22, the node-object is selected, and then, in FIG. 23, it is suppressed. Suppression of a node-object may also be provided with the use of a morphlet F=0.

FIGS. 21 to 25 illustrate examples of map modifications, performed on a local scale, with the tool and method according to the invention.

FIG. 21 is based on the example of FIG. 15, but in FIG. 21 intermittency is set to p=0.2, and only three levels are added. The morphlet below (F21) relates to this figure:

F21

\Morphlet MOl {

Function ( (X*X+Y*Y) <=1?1 : 0.0) ;
Somm /*!80*/ OLDVALUE+=NEWVALUE;

}
\ParamsNode P1 {

Morphlet MOl;
H 0.5;
Ksi 1 ;
Intermit RAND ( 1 . ) <0 .2 ;
Dec 0 ;

}
\ParamsNode nulll {

H O ;

}
\Map M1 {

Width 512;
Height 512;
Level 11;
Wrap 3;
Seed 100;
Default nulll;
Nodeset P1 /* ! 10{0} {2}*/ (nPROF>=(0) && nPROF<=(2));

}

Further local modifications are performed. In FIG. 22, the node-object is selected with the screen target 23. The modification consists in the suppression of the selected node and its dependant nodes. FIG. 23 illustrates the resulting map.

The following morphlet corresponds to FIG. 23:

F23

\Morphlet MOl {

Function ( (X*X+Y*Y) <=1?1 : 0.0) ;
Somm /*!80*/ OLDVALUE+=NEWVALUE;

}
\ParamsNode P1 {

Morphlet MOl;
H 0.5;
Ksi 1;
Intermit RAND (1. ) <0.2;
Dec 0;

}
\ParamsNode nulll {

H 0;

}
\Map M1 {

Width 512;
Height 512;
Level 11;
Wrap 3;
Seed 100;
Default nulll;
Nodeset P1 /* ! 10{0} {2}*/ (nPROF>=(0) && nPROF<=(2));
Modifier 21* Node {
Morphlet _NIL_;

}
}

FIGS. 24 and 25 show the selection of a node-object 51 (FIG. 24), and its modification (FIG. 25). The modification consist in a modification of the morplet or function F, as shown herebelow:

F25

\Morphlet MOl {

Function ( (X*X+Y*Y) <=1?1 : 0.0) ;
Somm /*!80*/ OLDVALUE+=NEWVALUE;

}
\Morphlet MaD_5acd58e {

Function ( (X*X+Y*Y) <=1?1 : 0.0) ;
Somm /*!80*/ OLDVALUE+=NEWVALUE;
SigmaX 0.98 ;
SigmaY 0 . 98 ;

}
\Morphlet MaD_700ef62e {

Function ( (X*X+Y*Y) <=1?1 : 0.0) ;
Somm /*!80*/ OLDVALUE+=NEWVALUE;
SigmaX 0.98 ;
SigmaY 0.1176 ;

}
\ParamsNode P1 {

Morphlet MO1;
H 0.5;
Ksi 1;
Intermit RAND (1. )<0.2;
Dec 0;

}
\ParamsNode nulll {

H 0;

}
\Map M1 {

Width 512;
Height 512;
Level 3;
Wrap 3;
Seed 100;
Default nulll;
Nodeset P1 /* ! 10{0} {2}*/ (nPROF>=(0) && nPROF<=(2));
Modifier 1* Node {
Morphlet MaD_700ef62e;
RecY 0.1176;

}

Modifier 21* Node {
Morphlet NIL ;

}

Modifier 1* SubTree {
Morphlet MaD_700ef62e;
RecY 0.1176;

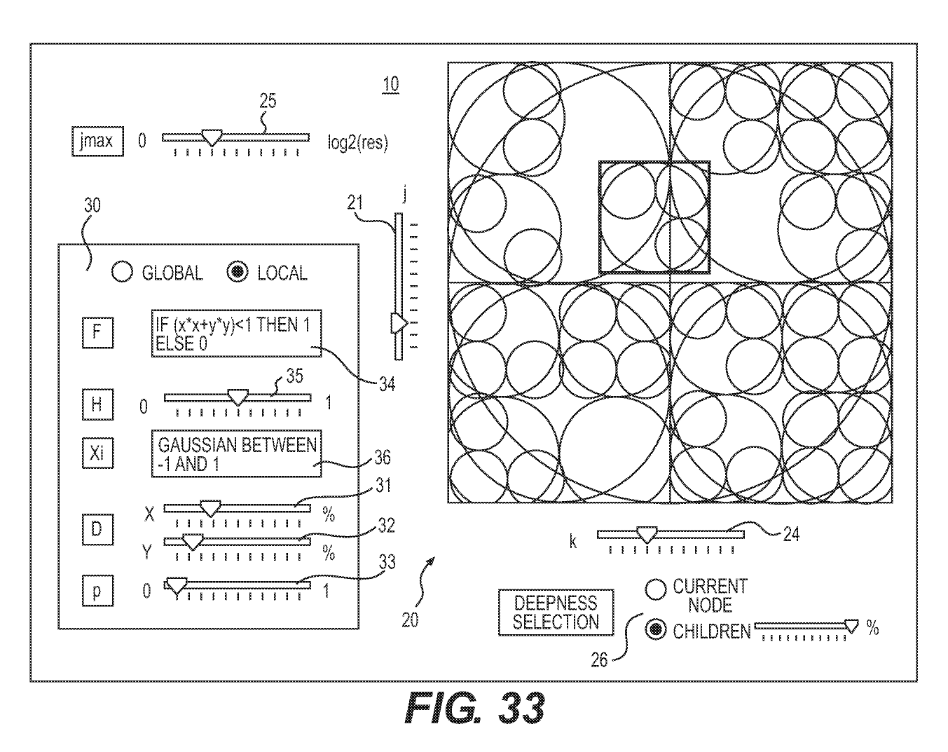

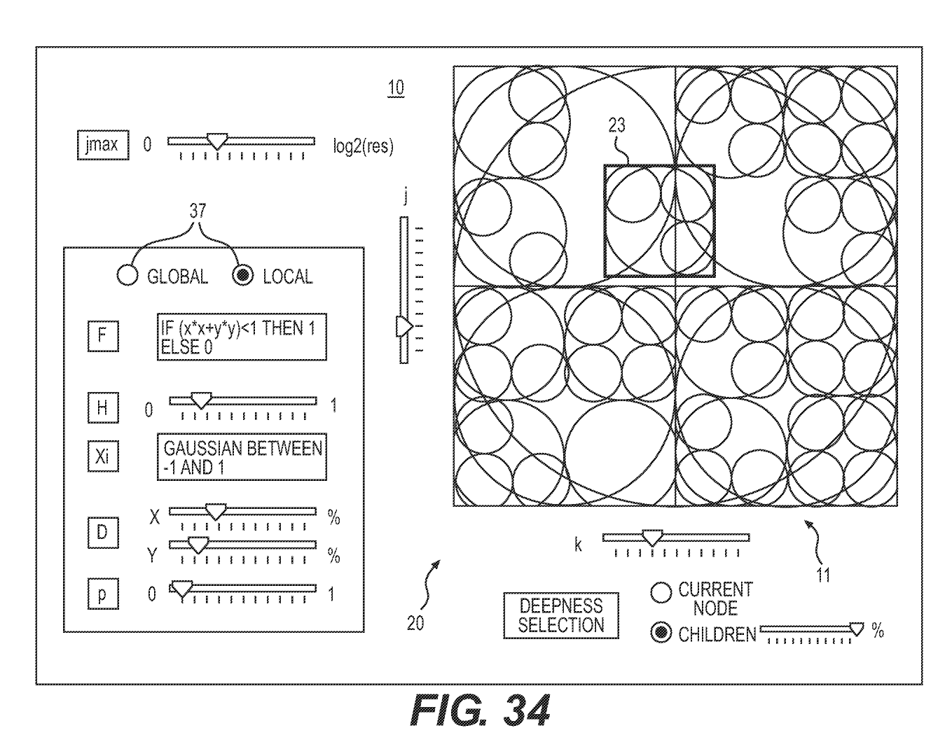

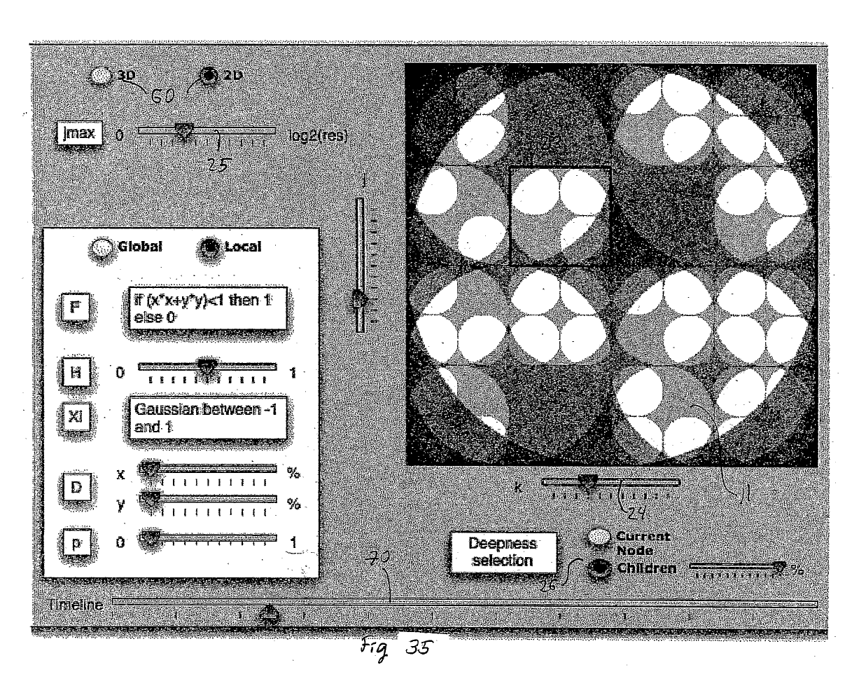

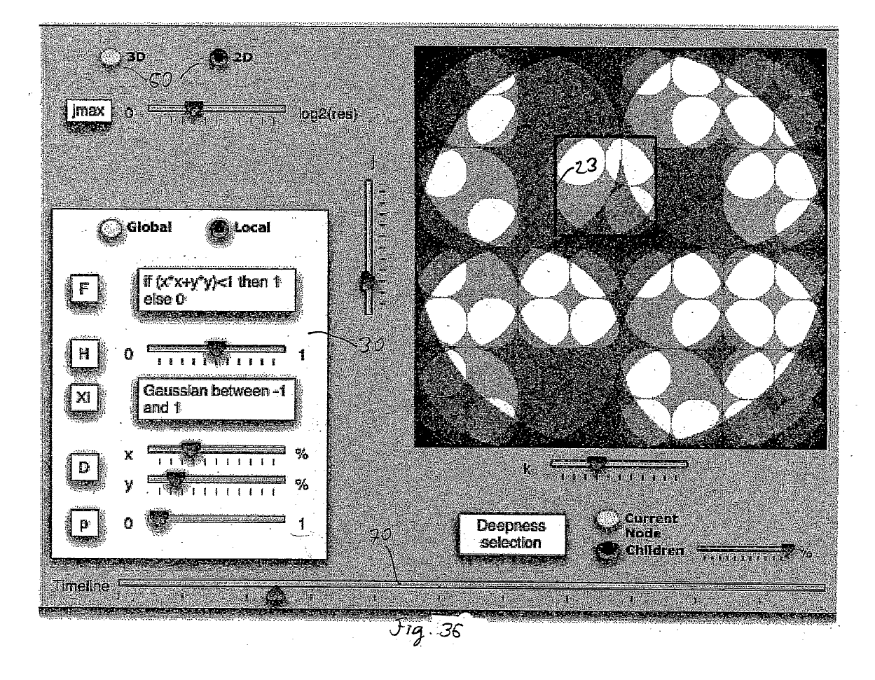

Further examples of modifications are provided in FIGS. 33 to 37. In FIG. 33; the values of D are modified from the original values (zero) of FIG. 32. In FIG. 34, the value of H is also modified.

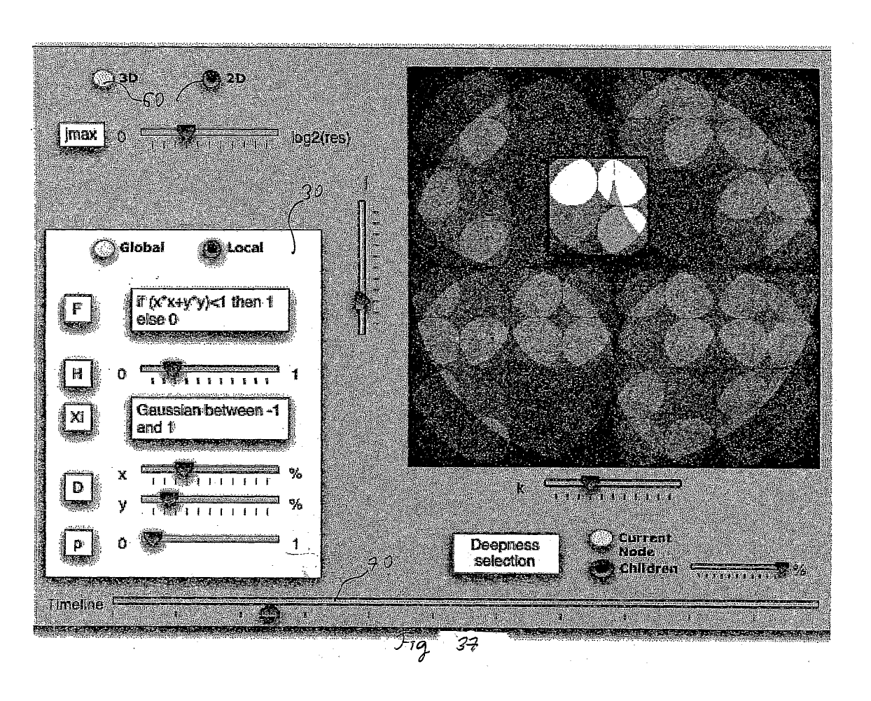

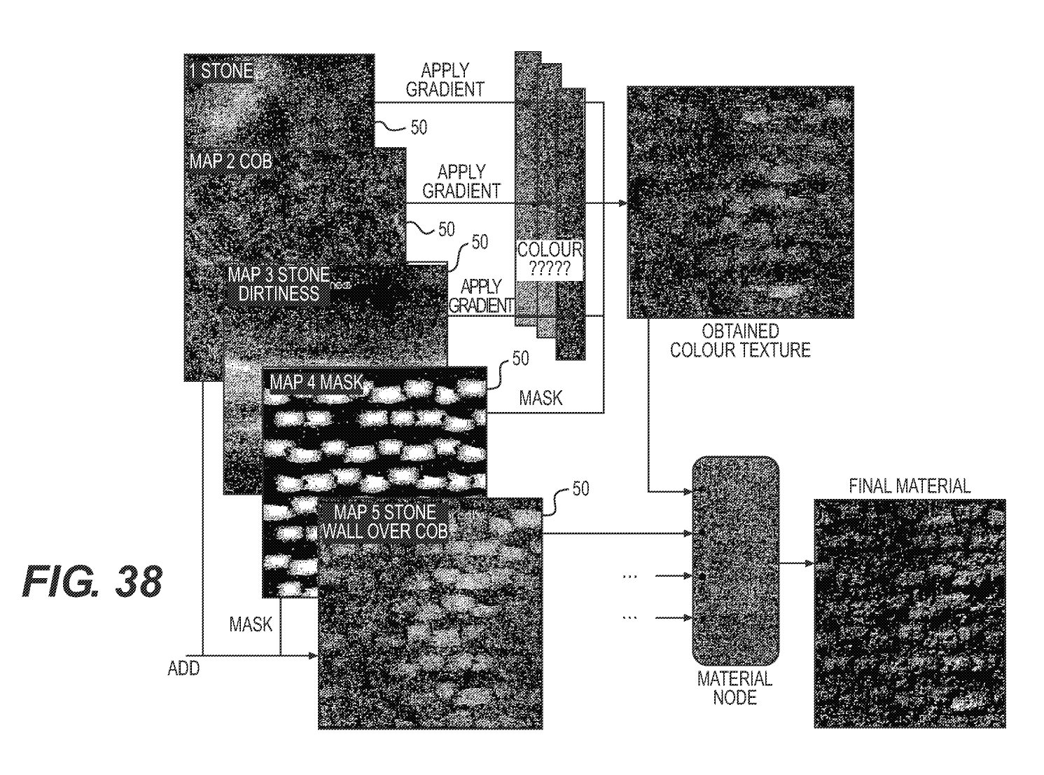

FIGS. 35, 36 and 37 provide variants of the interface 10. A 2D/3D selector 60 is added, to select the value of n. A timeline 70 is also added, to allow a time value to any time-dependant parameter. These modified interfaces may be helpful to allow to work with different types of shaders. FIGS. 36 and 37 also illustrate a modification of some parameters similar to the modifications of FIGS. 33 and 34. FIG. 38 illustrates an example of the use of procedural maps. In this example, different maps are combined to provided a virtual representation of a complex material, such as a wall, provided with stones of different sizes and shapes.

It should be realized that while the preferred embodiment of this invention is described and illustrated with texture maps, the method and device of the invention could also be implemented for use with other types of maps. For instance, in the field of shader, the method and devices of the invention also applies to the following types of maps: displacement, bump, reflectivity, specularity, ambient color, diffuse color, specular color, transparency, color, shininess, self-emission, anisotropy, refractive index, etc.

In an alternative embodiment, the present invention could also be provided as a plug-in to an existing software.

The above described arrangements are only used for example only. Modifications and alternative arrangements could be provided by those skilled in the art without departing from the spirit and scope of the present invention. The appended claims are intended to cover such modifications and arrangements.

1-32. (canceled)

33. A procedural map modification tool for use with a tree driven procedural map comprising a plurality of levels each having at least one node associated to at least one parameter, comprising:
a node selection tool allowing the selection of at least one node of one level among the plurality of nodes of a map to be modified;
a parameter setting tool allowing the modification of at least one parameter of the selected node;
a processing unit, for the processing of said parameters to generate a map;
operating instructions, for the operation of said tool and namely of the processing unit.

34. The tool of claim 33, adapted for the modification of a tree driven procedural map based on the following equation:
ΣF(2^{j}x−k)
(j, k)εT
wherein:
F is a function Rⁿ→R
x is a vector of the type (x₁, x₂, . . . , xₙ);
T is a tree comprising nodes (j, k) and wherein
j indicates the current level, among a total potential number of levels jmax (j ε(0, 1, 2, . . . , jmax)
k is a displacement vector for each node N and of the type (x₁, x₂, . . . , xₙ)

35. The tool of claim 34, being adapted for the modification of at least one parameter selected in the list comprising: the morphlet F, the maximum number of levels (jmax).

36. The tool of claim 34, wherein said node selection tool is provided with a deepness selection unit allowing the selection of a given level (j) of said tree.

37. The tool of claim 34, said node selection tool comprising a movable screen target, for the localisation and/or selection of a node-object.

38. The tool of claim 37, wherein said movable screen target is operable with a computer cursor displacement device.

39. The tool of claim 33, adapted for the modification of a tree driven procedural map based on the following equation:
Σ2^{jH}F(2^{j}x−k)ξ_{(j,k)},
(j, k)εT_{D,p}
wherein:
F is a function Rⁿ→R
x is a vector of the type (x₁, x₂, . . . , xₙ);
T_{D,p} represents an tree provided with an intermittency parameter (p), and comprising nodes (j, k) and a displacement value (D), wherein j indicates the current level, among a total potential number of level jmax, j ε (0, 1, 2, . . . , jmax);
k is a displacement vector for each node N and of the type (x₁, x₂, . . . , xₙ);
H represents a Hurst parameter;
ε represents a random number.

40. The tool of claim 39, being adapted for the modification of at least one parameter selected in the list comprising: the function F, the current level (j), the maximum number of levels (jmax), a Hurst parameter (H), a random value (ξ), an intermittency parameter (p), a displacement value (D).

41. The tool of claim 39, wherein said node selection tool is provided with a deepness selection unit allowing the selection of a given level (j) of said tree.

42. The tool of claim 39, said node selection tool comprising a movable screen target, for the localisation and/or selection of a node-object.

43. The tool of claim 39, wherein said movable screen target is operable with a computer cursor displacement device.

44. The tool of claim 39, said map modification tool being comprised in a tree driven procedural map generation tool.

45. A procedural map generation tool, for the generation of tree driven procedural maps comprising a plurality of levels each having at least one node associated to at least one parameter, comprising:
a map parameter input unit, for the input of the procedural map parameters;
a map processing unit, for the processing of the parameters;
operating instructions, for the operation of said tool and namely of the processing unit;
a map modification tool, comprising:
a node selection tool allowing the selection of at least one node of one level among the plurality of nodes of a map to be modified;
a parameter modification tool allowing the modification of at least one parameter of the selected node.

46. The procedural map generation tool of claim 45, further comprising an output for a map display unit, allowing the presentation of said map on a display.

47. A process for modifying a procedural map for use with a tree driven procedural map comprising a plurality of levels each having at least one node associated to at least one parameter, comprising the steps of:
providing a node selection tool allowing the selection of at least one node of one level among the plurality of nodes of a map to be modified;
select a given node according to a given input;
provide a parameter modification tool allowing the modification of at least one parameter of the selected node;
modify said parameter of said node based on a given input;
calculate a modified map based on the modified parameters.

48. The process of claim 47, wherein the modified parameters are recursively affected to the children nodes of said selected node.

49. The process of claim 47, wherein the tree driven procedural map is based on the following equation:
ΣF (2^{j}x−k)
(j, k)εT
wherein:
F is a function Rⁿ→R
x is a vector of the type (x₁, x₂, . . . , xₙ);
T is a tree comprising nodes (j, k) and wherein
j indicates the current level, among a total potential number of levels jmax (j ε(0, 1, 2, . . . , jmax)
k is a displacement vector for each node N and of the type (x₁, x₂, . . . , xₙ)

50. The process of claim 49, wherein the modifiable parameters are selected in the list comprising: the morphlet F, the maximum number of levels (jmax).

51. The process of claim 49, wherein said procedural map is a texture map.

52. The process of claim 49, wherein said procedural map type is selected from the list comprising: displacement, bump, reflectivity, specularity, ambient color, diffuse color, specular color, transparency, color, shininess, self-emission, anisotropy, refractive index.

53. The process of claim 49, wherein the tree comprises an intermittency parameter (p).

54. The process of claim 49, further comprising a Hurst parameter (H).

55. The process of claim 49, further comprising a random value (ξ).

56. The process of claim 49, wherein the sum is a generalised sum.

57. The process of claim 49, wherein the map is time dependant.

58. The process of claim 47, wherein the tree driven procedural map is based on the following equation:
Σ2^{-jH}F(2^{j}x−k)ξ_{(j, k)}
(j, k)εT_{D,p}
wherein:
F is a function Rⁿ→R
x is a vector of the type (x₁, x₂, . . . , xₙ);
T_{D,p} represents an tree provided with an intermittency parameter (p), and comprising nodes (j, k) and a displacement value (D), wherein
j indicates the current level, among a total potential number of level jmax (j ε(0, 1, 2, . . . , jmax)
k is a displacement vector for each node N and of the type (x₁, x₂, . . . , xₙ)
H represents a Hurst parameter;
ξ represents a random number.

59. The process of claim 58, wherein the modifiable parameters are selected in the list comprising: the morphlet F, the maximum number of levels (jmax), a Hurst parameter (H), a random number (ξ), an intermittency parameter (p), a displacement value (D).

60. The process of claim 58, wherein said procedural map is a texture map.

61. The process of claim 58, wherein said procedural map type is selected from the list comprising: displacement, bump, reflectivity, specularity, ambient color, diffuse color, specular color, transparency, color, shininess, self-emission, anisotropy, refractive index.

62. The process of claim 58, wherein said sum is a generalised sum.

63. The process of claim 58, wherein the map is time dependant.

64. A software product readable by a computer and encoding instructions for executing a computer process for modifying a procedural map for use with a tree driven procedural map comprising a plurality of levels each having at least one node associated to at least one parameter, comprising the steps of:
providing a node selection tool allowing the selection of at least one node of one level among the plurality of nodes of a map to be modified;
select a given node according to a given input;
provide a parameter modification tool allowing the modification of at least one parameter of the selected node;
modify said parameter of said node based on a given input;
calculate a modified map based on the modified parameters.
